(19) United States
(12) Patent Application Publication
(10) Pub. No.: US 2025/0003259 A1
(43) Pub. Date: Jan. 2, 2025

(54) RAM LOCK

(71) Applicant: RONALD A. MOREIRA, FULTON, TX (US)

(72) Inventor: RONALD A. MOREIRA, FULTON, TX (US)

(21) Appl. No.: 18/757,313

(22) Filed: Jun. 27, 2024

Related U.S. Application Data
(60) Provisional application No. 63/510,629, filed on Jun. 27, 2023.

(51) Int. Cl. E05B 47/00

(52) U.S. Cl. CPC E05B 47/0012; E05B 2047/002; E05B 2047/0056; E05B 2047/0084

(57) ABSTRACT

A ram lock assembly of the present application is configured to serve as an intelligent and practical approach to locking and securing a door remotely or manually. The mechanism consists of a bolt that is translatable into and out of a sheath located within a stable surface. The bolt is actuatable via a control box and a drive motor so as to locate the bolt between extended and retracted orientations. The mechanism can be retrofitted to an existing door or installed as part of new construction. A remote electronic device may be included to regulate operation of the bolt.

### CROSS REFERENCE TO RELATED APPLICATIONS

This application claims the benefit of an earlier filing date and right of priority to U.S. Provisional Application No. 63/510,629, filed 27 Jun. 2023, the contents of which is incorporated by reference herein in its entirety.

### BACKGROUND OF THE INVENTION

### 1. Field of the Invention

The present application relates to a locking device, and more particularly to a doorway locking device with remote operation and monitoring.

### 2. Description of Related Art

The United States Department of Justice reports that there are 2.5 million burglaries every year, more than half of them are home invasions. According to further crime study, there are four main categories of burglaries: completed burglary, forced entry, unlawful entry without force, and attempted forcible entry.

In the US, a home burglary happens every 15 seconds. This means that every day, about 4,800 burglaries take place. The summer months of June through August are when burglaries seem to happen most frequently, but this does not lessen the other scenarios that might happen at any time of year. Between the hours of 10 a.m. and 3 p.m. is when home invasions are most common; nevertheless, in 27.6% of all home burglaries, someone is home when the crime is being committed. Residences are but one subset of the locations wherein crimes involving forced entrance or entry by those with criminal intent occur. This also happens at institutions, businesses, and schools.

The occurrence of repeated attacks on institutions, schools, businesses, and homes or any establishment where there are groups of people has brought a heightened sense of the need for improved security. Procedures have been put in place, and many others have been contemplated but not implemented. Many of the methods may prove to be complicated to follow strictly and regularly. Routines and the lack of any sign of any immediate threat can lead to complacency. For example, failure to secure a door with a sturdy lock can lead to severe consequences if criminal activity suddenly appears.

Securing a door is one of the most important and easiest ways to ensure the security of a building. Many times, an authorized person will forget to secure a door. It may be because the person is overloaded with responsibility or just forgetful. Still, regardless of the circumstances, the door is unlocked and vulnerable to the entrance by an unauthorized person or persons with perhaps criminal intent. Often a person cannot remember if they locked the door or not and must physically return and check if they have locked the door. Modern technology can solve many issues with securing and locking a doorway entrance.

Although strides have been made, shortcomings remain. It is desired that an assembly be provided that provides a locking mechanism device that can operate a door and be paired with a device that can communicate and tell if a door is locked and can lock the door remotely also. The ability to know if a door is locked and combined with the ability to lock the door remotely, is a vast improvement in the security of any intuition or residence.

### BRIEF SUMMARY OF THE INVENTION

It is an object of the present application to provide an intelligent and practical approach to locking and securing a door remotely or manually. It is desired that such a device be operable with any conventional door commonly used in schools, homes, and offices, but that it is also suitable for use with semi-truck trailers to secure the rear doors of a trailer. The Ram lock includes a locking mechanism internally that is operable to selectively deploy in times of need to secure the internal people, product, or items from the outside. The product can be retrofitted to an existing door or installed as part of new construction. It is an object to use heavy-duty plates attached to the door through holes drilled into the door. The plates are held tightly and securely to the door by through bolts that are welded to the plates for a secure and sturdy connection.

It is a further object of the present application that the locking mechanism is able to be in communication with a motion sensor so as to be automatically or remotely operated/activated upon detection of motion within a selected proximity to the locking mechanism. The locking mechanism is able to be remotely controlled over a network to allow activation and deactivation from remote locations distal from the locking mechanism.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a pair of ram lock assemblies according to an embodiment of the present application.

FIG. 2 is an internal perspective view of one of the ram lock assemblies of FIG. 1.

FIG. 3 is a side perspective view of the ram lock assembly of FIG. 2.

FIGS. 4 and 5 are additional perspective and front views of the ram lock assembly of FIG. 2.

FIG. 6 is an enlarged perspective view of a release pin in the ram lock assembly of FIG. 2.

While the application is susceptible to various modifications and alternative forms, specific embodiments thereof have been shown by way of example in the drawings and are herein described in detail. It should be understood, however, that the description herein of specific embodiments is not intended to limit the application to the particular forms disclosed, but on the contrary, the intention is to cover all modifications, equivalents, and alternatives falling within the spirit and scope of the application as described herein.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The ram lock assembly of the present application is configured to provide an intelligent and practical approach to locking and securing a door remotely or manually. The Ram lock consists of a mechanism attached to the inside lower section of a door. The entry is usually an outside entrance/exit door. The product can be retrofitted to an existing door or installed as part of new construction. Two heavy-duty plates are attached to the door through holes drilled into the door. The plates are held tightly and securely to the door by through bolts that are welded to the plates for a secure and sturdy connection.

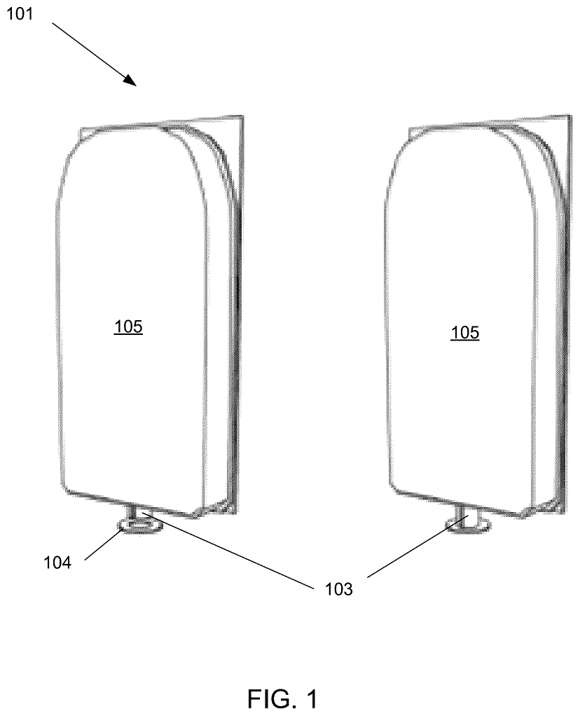

Referring now to FIG. 1 in the drawings, a perspective view of a ram lock assembly is provided. Ram lock assembly 101 includes a bolt 103 that selectively extends beneath casing 105 so as to make contact with a hole in the ground beneath a door. Casing 105 is configured to surround or encapsulate the internal components and hardware used to operate the bolt mechanism. Assembly 101 is shown in two different stages of operation in FIG. 1. In the first stage of operation bolt 103 is in an elevated position above the ground and is outside of the sheath 104 in the ground. In the second representation bolt 103 is lowered into this sheath 104.

Ram lock assembly 101 is configured to attach to a door in an entryway. It is understood that the assembly is secured to a lower portion of the door so as to be near the ground. Assembly 101 is configured to provide security so as to limit passage through the doorway in times of emergency or for general use and protection. Casing 105 protect the electronics and locking mechanism within assembly 101 and is ideally made from hardened rigid material. Operational mechanisms are all contained inside the casing 105 that is sealed off. The enclosure protects both the components and the operating mechanism, and it can be opened for maintenance, battery replacement, or charging.

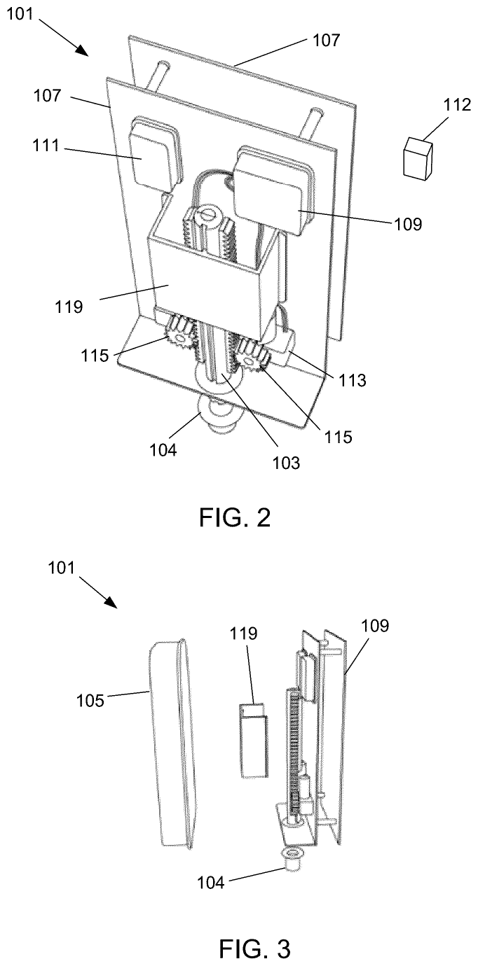

Referring now to FIG. 2 in the drawings, an upper perspective view of the interior of ram lock assembly 101 is provided. Casing 105 has been removed for clarity. Assembly 101 includes opposing steel plates 107 that are configured to be located on opposite sides of a door (not shown). These are constructed of high grade steel and include one or more welded through door bolts as fasteners. The fasteners are used to permanently mount the plates 107 to the door. Through bolts that are welded to the plates maintain the plates' tight and stable attachment to the door. Ideally, the lock is positioned 1.5 inches from the door's bottom. Four binding screw posts on each corner of an outside 16-gauge stainless steel plate are welded to the plate in one embodiment. For ultimate security, both plates are fastened to the door after the interior plate is mounted to four binding screws.

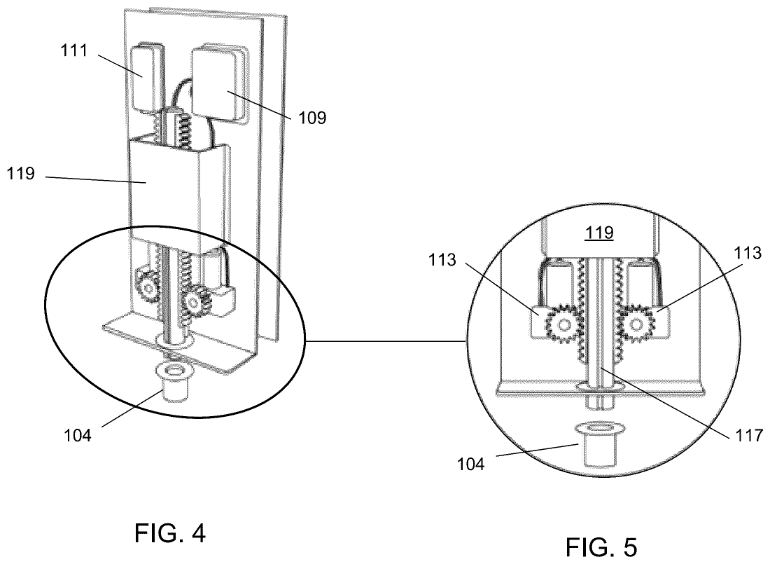

Referring now also to FIGS. 3-5 in the drawings, assorted views of ram lock assembly 101 are provided. In particular, FIG. 3 illustrates a side view of assembly 101. FIGS. 4 and 4 are used to provide a more close up view of the locking components within assembly 101.

Assembly 101 is configured to promote remote operation. This allows a user to be remote from the assembly while providing control to operate or activate bolt 103 between an elevated position and a lowered position. To permit remote operation, assembly 101 includes a long-lasting battery 109.

Assembly 101 further includes an electronic control box 111 which may include a PCB and Bluetooth capabilities. Control box 111 is configured to process, transmit, and receive data related to the operation of bolt 103 and to send and receive command data. Control box 111 includes an input output interface to allow data to be transmitted and received between electronic devices, such as remote electronic devices 112.

An example of a remote electronic device 112 may include a motion sensor. The motion sensor is configured to send command data to box 111 when motion is detected. Control box 111 configured to process the command data and automatically activate the locking mechanism (bolt 103) to a locked/lowered position. Another example of a remote electronic device 112 is a remote cell phone or other control device that communicates with control box 111 and/or any other devices 112. A user may be able to use device 112 to selectively raise or lower bolt 103 through operation of device 112. Control box 111 also includes one or more databases or storage devices for temporary or permanent storage, and to allow maintenance of software.

Control box 111 is powered through battery 109. Battery 109 may be selectively removed and replaced, or maybe configured to be rechargeable. In some embodiments it is conceived that battery 109 may be wired through the building in which it is located so as to receive a constant electrical input. In such situations battery 109 may be used as a backup in case of power outage. Regardless of the exact wiring configuration or supply of power, assembly 101 is configured to operate via electrical energy to selectively operate bolt 103.

The ram lock system's ability to communicate with authorized people, including through the use of device-specific key fobs created specifically to operate the system and assigned to the ram lock security key fob receiver is one of its unique features. Any number of these key fobs may be produced and distributed to security personnel. Unauthorized people are prevented from manually operating the system by an on-site fingerprint recognition security system, which also enables the door to be unlocked in an emergency.

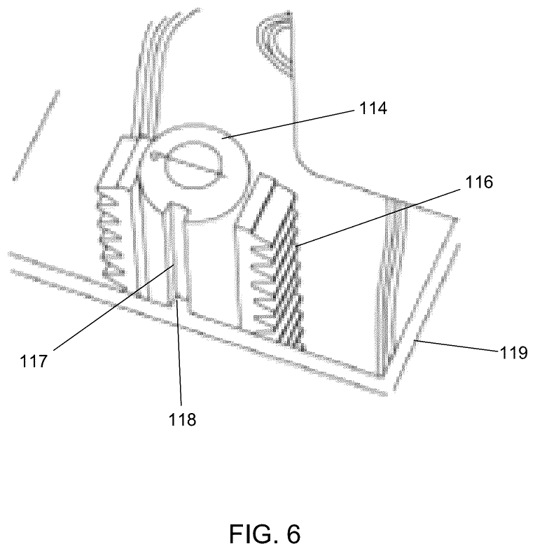

As seen in particular with FIGS. 4 and 5, one or more drive motors 113 may be used to select the position of bolt 103. As seen in the figures, a geared mechanism is used to raise and lower bolt 103. Motors 113 or in communication with a gear 115. Motors 113 selectively rotate gear 115 to raise or lower bolt 103. As seen in the figures, two motors 113 are illustrated. Bolt 103 may include external teeth 116 to coincide with gears 115.

Bolt 103 includes a slot 117 along its length. Slot 117 is configured to align with a rib 118 found in steel guide plate 119. Plate 119 is coupled to plate 107 and is used to help align bolt 103. The rib of plate 119 is located on an internal surface and passes through slot 117. The use of slot 117 and the rib 118 can be referred to as a keyway slot and is useful in maintaining alignment. The keyed (slotted) bolt mechanism 114 is driven up and down on command by the gears 115 matching up with a geared rack attached to it. The rib 118 remaining within slot 117 as the bolt 103 translates.

Referring now also to FIG. 6 in the drawings, an enlarged top perspective view of bolt 103 is illustrated. This enlarged view provides a better illustration of rib 118 and slot 117. Teeth 116 are also more clearly visible along the exterior surface of bolt 103. Bolt 103 may also include a release pin 121 located at a top portion of bolt 103. Release pin 121 is useful to disengage bolt 103 from other portions of the locking mechanism. This is useful in times where the electronic functions of the assembly have failed or when manual operation is required. Assembly 101 has been built and assembled to provide effortless high security for extended life. High strength materials and reputable manufacturing practices ensure that the assembly provides the highest security for home and building access.

In operation, the ram lock assembly is a device that is fastened to a door's inside bottom portion, with a matching receiver mounted in the interior of the home, or building. In most cases, the entry is a door leading outside. The product can be placed as part of new construction or as a retrofit to an existing door. Via holes drilled into the door, two large plates are fastened to the door. Through bolts that are welded to the plates maintain the plates' tight and stable attachment to the door. The lock is positioned 1½ inches from the door's bottom. Four binding screw posts on each corner of an outside 16-gauge stainless steel plate are welded to the plate. For ultimate security, both plates are fastened to the door after the interior plate is mounted to four binding screws.

For easy up-and-down movement, the sliding lock mechanism is linked to the inside plate by two screws. Two motor-driven gear boxes that are mounted on a gear box holder are used to raise and lower the lock. The gear box is secured with a safety clip, preventing forceful entry from moving it. The notch is grooved into the deadbolt and faced outward when it is being welded to the slider plate. The safety clips help to keep the deadbolt steady. The battery and software with a rapid wire release to the drive motor are both housed under an outside cover for the entire mechanism, making battery replacement simple. The security of any facility is greatly enhanced by the ram lock device, which gives users the power to remotely lock and unlock any door through the key fob technology or ram lock app.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A locking mechanism, comprising:
a casing;
a sheath within the casing;
a bolt, the bolt being partially surrounded by the sheath;
a drive motor within the casing and in communication with the bolt, the drive motor configured to selectively position the bolt relative to the sheath;
a battery; and
a control box in communication with the drive motor and configured to regulate operation of the drive motor to selectively move the bolt position.

2. The locking mechanism of claim 1, wherein the bolt includes a slot for a keyway.

3. The locking mechanism of claim 2, further comprising:
a plate with a rib configured to pass within the slot, the plate configured to maintain alignment of the bolt, the rib remaining within the slot as the bolt translates.

4. The locking mechanism of claim 1, wherein the drive motor is gear driven.

5. The locking mechanism of claim 4, wherein the slot includes gear teeth to engage the gear of the drive motor.

6. The locking mechanism of claim 1, wherein the casing is mountable to a trailer.

7. The locking mechanism of claim 1, wherein the casing is mountable to a door.

8. The locking mechanism of claim 1, further comprising:
a remote electronic device.

9. The locking mechanism of claim 8, wherein the remote electronic device is configured to regulate operation of the bolt by communicating with the control box, the remote electronic device configured to send command data to the control box, the control box configured to automatically translate the bolt in response to the command data.

10. The locking mechanism of claim 8, wherein the remote electronic device is a motion sensor, the control box configured to translate the bolt in response to motion detected by the remote electronic device.

11. The locking mechanism of claim 8, wherein the remote electronic device is configured to selectively regulate operation of the drive motor.

12. The locking mechanism of claim 1, wherein the battery is rechargeable.
